(19) United States
(12) Patent Application Publication
(10) Pub. No.: US 2025/0094773 A1
(43) Pub. Date: Mar. 20, 2025

(54) ANOMALY DETECTING METHOD IN SEQUENCE OF CONTROL SEGMENT OF AUTOMATION EQUIPMENT USING GRAPH AUTOENCODER

(71) Applicant: UDMTEK CO., LTD., Suwon-Si (KR)

(72) Inventors: Gi Nam Wang, Yongin-Si (KR); Jun Pyo Park, Suwon-Si (KR); Seung Woo Han, Hwaseong-Si (KR); Geun Ho Yu, Suwon-Si (KR); Min Young Jung, Hwaseong-Si (KR); Hee Chan Yang, Suwon-Si (KR); Seung Jong Jin, Suwon-Si (KR)

(73) Assignee: UDMTEK CO., LTD., Suwon-Si (KR)

(21) Appl. No.: 18/965,236

(22) Filed: Dec. 2, 2024

Related U.S. Application Data
(62) Division of application No. 17/813,738, filed on Jul. 20, 2022.

(30) Foreign Application Priority Data
Jul. 23, 2021 (KR) 10-2021-0097053

(51) Int. Cl. G06N 3/045; G06F 18/214; G06F 18/241

(52) U.S. Cl. CPC G06N 3/045; G06F 18/214; G06F 18/241

(57) ABSTRACT

A method, of training an anomaly detecting model using a plurality of pieces of graph data, includes: (a) inputting one piece of graph data that has not yet been input, among the plurality of pieces of graph data, to a graph neural network (GNN) AutoEncoder calculating a probability of each edge as input data; (b) calculating a difference value (hereinafter, “edge difference value”) between an edge probability value of reconstructed data output by the GNN AutoEncoder and an edge value of the input data; (c) calculating an average value (hereinafter, “positive edge loss”) of a positive edge and an average value (hereinafter, “negative edge loss”) of a negative edge using the edge difference value, and calculating an edge prediction loss value of the reconstructed data by summing the positive edge loss and the negative edge loss; (d) retraining the GNN AutoEncoder until the edge prediction loss value is minimized.

### CROSS-REFERENCE TO RELATED APPLICATION

This is a divisional application of U.S. patent application Ser. No. 17/813,738,filed on Jul. 20, 2022, which claims priority to and the benefit of Korean Patent Application No. 2021-0097053, filed on Jul. 23, 2021. The content of these applications are incorporated herein by reference in their entirety.

### BACKGROUND

### 1. Field of the Invention

The present disclosure relates to a method of detecting presence or absence of anomalies in automation equipment, and more particularly, to a method of detecting presence or absence of anomalies in repeated cycles by analyzing programmable logic controller (PLC) logic.

### 2. Discussion of Related Art

The contents described in this section merely provide background information for embodiments described herein and does not necessarily constitute the related art.

A programmable logic controller (PLC) has been mainly used for building automation lines, and is driven by the specifications (PLC control logic code) of PLC control logic written through operation symbols such as AND/OR and relatively simple functions such as timer/function block. The control logic is defined using a memory address of the PLC hardware. In this case, the memory address of the PLC hardware is called a contact point. Automation lines operate by defining an input/output relationship to these contact points and controlling values of the contact points for each situation.

In general, the PLC control logic has numerous contact points depending on the scale of the automation lines. Because the operation of the automation equipment follows the unchanging control logic defined on the PLC, operations of automation equipment in a normal and general automation process and sensor values of various sensors related to the operations show a uniform and repetitive pattern, that is, a kind of pattern.

Even when there is no change in the control logic, the operations of the automation equipment and the sensor values may show aspects different from the regular operations and the sensor values that have been shown before, which suggests that any anomaly or change has occurred in the automated processes and equipment. When anomalies and changes in the process are accumulated and are left unattended, the anomalies and changes in the process lead to process interruption, which in turn lead to production delays and a decrease in an operation rate of the automation equipment. Therefore, it is necessary to detect and continuously track these changes to eliminate the causes of the anomalies and to return to normal and regular operations and signal patterns. There is a need for a method of continuously monitoring an operating pattern in a process.

### RELATED ART DOCUMENT

### Patent Document

(Patent Document 0001) Korean Patent No. 10-1527419

### SUMMARY OF THE INVENTION

The present disclosure is directed to providing a method of training a model capable of detecting anomaly of an operation sequence of automation equipment.

The present disclosure is directed to providing a method of generating graph data for training an anomaly detecting model.

Objects of the present disclosure are not limited to the above-described objects, and other objects that are not mentioned will be clearly understood by those skilled in the art from the following description.

According to an aspect of the present disclosure, there is provided a method of generating graph data for detecting anomaly including: (a) classifying each section in which a contact point value changes in log data expressed as a Gantt chart as one state; (b) identifying a major state in the classified states, and converting the log data into a node matrix according to the order of occurrence of the major state; and (c) converting the log data into edge index data by defining a connection relation between the classified states, expressing the classified state as a node, and expressing the connection relation of the classified state as a positive edge and a negative edge to convert the log data into positive edge index data and negative edge index data.

The operation (a) may include assigning an identification feature for classifying a state according to the changed contact point value.

The operation (b) may include counting the number of states having the same identification feature and identifying a state having a number greater than or equal to a preset value as the major state.

The operation (b) may include assigning an identification code to the identified major state in a One Hot Encoding format.

The operation (b) may include further adding at least one sensor value to each section corresponding to the major state, and converting the log data into node matrix data according to the order of occurrence of the major state to which the sensor value is added.

The operation (b) may include selecting and adding one representative value when there are two or more sensor values output from one sensor in the section.

The connection relationship may be a necessary condition or an exclusive condition.

The operation (c) may deleting a node that does not correspond to the major state from the node matrix data, and connecting previous and subsequent nodes connected to the deleted node to convert the log data into positive edge index data.

The operation (c) may convert edges, other than the positive edge, among all edges that can be generated between nodes into negative edge index data.

The method of generating graph data for detecting an anomaly according to the present disclosure may be implemented in a form of a computer program written to allow a computer to execute each operation of the method of generating graph data and recorded on a computer-readable recording medium.

According to another aspect of the present disclosure, there is provided a method of training an anomaly detecting model using a plurality of pieces of graph data generated may including: (a) inputting one piece of graph data that has not yet been input, among the plurality of pieces of graph data, to a graph neural network (GNN) AutoEncoder calculating a probability of each edge as input data; (b) calculating a difference value (hereinafter, “edge difference value”) between an edge probability value of reconstructed data output by the GNN AutoEncoder and an edge value of the input data; (c) calculating an average value (hereinafter, “positive edge loss”) of a positive edge and an average value (hereinafter, “negative edge loss”) of a negative edge using the edge difference value, and calculating an edge prediction loss value of the reconstructed data by summing the positive edge loss and the negative edge loss; (d) retraining the GNN AutoEncoder until the edge prediction loss value is minimized; and (e) repeatedly executing the operations (a) to (d) when there remains graph data that has not yet been input, among the plurality of pieces of graph data.

A value of the positive edge of the graph data may be set to “1” and a value of the negative edge may be set to “0.”

The method of training an anomaly detecting model may further include: (f) setting a reference threshold value for determining the positive edge or the negative edge according to the calculated edge probability value; (g) inputting one piece of graph data that has not yet been input, among the plurality of pieces of graph data, to a GNN AutoEncoder calculating a probability of each edge as input data; (h) converting the edge probability value of the reconstructed data output by the GNN AutoEncoder into the positive edge or the negative edge according to the reference threshold value; (i) calculating accuracy between the reconstructed data converted into the positive edge or the negative edge and the input data; (j) repeatedly executing operations (f) to (i) when there remains graph data that has not yet been input, among the plurality of pieces of graph data; and (k) when all of the plurality of pieces of graph data are input to the GNN AutoEncoder as input data, calculating an average and a standard deviation of the accuracy, and subtracting a standard deviation value in which a preset parameter is reflected from the average value to be set as an anomaly detecting standard.

The method of training an anomaly detecting model according to the present disclosure may be implemented in a form of a computer program written to allow a computer to execute each operation of the method of training an anomaly detecting model and recorded on a computer-readable recording medium.

Other specific details of the invention are included in the detailed description and drawings.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a reference diagram of an overall flow of the present invention disclosed in the present disclosure;

FIG. 2 is a schematic flowchart of a method of generating graph data according to the present disclosure;

FIG. 3 is a reference diagram for a collection of log data;

FIG. 4 is a reference diagram for state classification and state identification features;

FIG. 5 is a reference diagram for identifying major states;

FIGS. 6 and 7 are reference diagrams for adding sensor values for each section;

FIG. 8 is a reference diagram in which log data is converted into node matrix data;

FIG. 9 is a reference diagram illustrating that a connection relationship is defined between adjacent states;

FIG. 10 is a reference diagram for removing a node corresponding to a minor state;

FIG. 11 is a reference diagram of a method of generating a negative edge index;

FIG. 12 is a reference diagram for relationships between log data, node matrix data, positive edge index data, negative edge index data, and graph data;

FIG. 13 is a reference diagram of relationships between graph data and cycles;

FIG. 14 is a reference diagram of AutoEncoder;

FIG. 15 is a schematic flowchart of a method of training an anomaly detecting model according to the present disclosure;

FIG. 16 is a reference diagram of the method of training an anomaly detecting model according to the present disclosure;

FIG. 17 is a schematic flowchart of reference setting of the anomaly detecting model according to the present disclosure; and

FIGS. 18 and 19 are reference diagrams of the reference setting of the anomaly detecting model according to the present disclosure.

### DETAILED DESCRIPTION OF EXEMPLARY EMBODIMENTS

Various advantages and features of the present disclosure and methods accomplishing them will become apparent from the following description of embodiments with reference to the accompanying drawings. However, the present disclosure is not limited to the embodiments disclosed herein and may be implemented in various forms. The embodiments are provided so that the disclosure of the present specification is complete and those skilled in the art can easily understand the scope of the present disclosure. Therefore, the present disclosure will be defined by the scope of the appended claims.

The terminology used in the present disclosure is for the purpose of describing embodiments, and is not intended to limit the scope of the present disclosure. In the present disclosure, the singular also includes the plural unless otherwise specified in the context. Throughout this specification, the term “comprise” and/or “comprising” will be understood to imply the inclusion of stated components, not the exclusion of one or more other components.

Like reference numerals refer to like elements throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that the first component described below may be the second component within the technical scope of the present disclosure.

Unless defined otherwise, all terms (including technical and scientific terms) used in the present specification have the same meaning as meanings commonly understood by those skilled in the art to which the present disclosure pertains. In addition, terms as defined in a commonly used dictionary are not to be ideally or excessively interpreted unless explicitly defined otherwise. Hereinafter, embodiments of the present disclosure will be described with reference to the accompanying drawings.

Definitions of terms used in the present disclosure are as follows.

A programmable logic controller (PLC) is a control device with high autonomy that enables program control by adding a numerical calculation function to a basic sequence control function (replacement of functions such as a relay, a timer, and a counter with semiconductor devices such as an integrated circuit (IC) and a transistor). For reference, in the US Electrical Industrial Standards, “electronic device of digital operation that uses a programmable memory to perform special functions such as logic, sequence, timer, counter, and operation through digital or analog input/output modules and controls various types of machines or processors” is defined.

Log data is a result obtained by collecting PLC contact data at regular intervals. Depending on an operation of equipment on the line, values of contact points on the PLC related to the operation changes. Whenever the values of contact point on the PLC changes, a log is collected. The log data is data represented by [contact name, value, time] and is value data of a specific contact point at a corresponding time.

Cycle means a section in which the contact data is constantly repeated. The unit of the cycle may be various, such as a plant, a line, a process, etc.

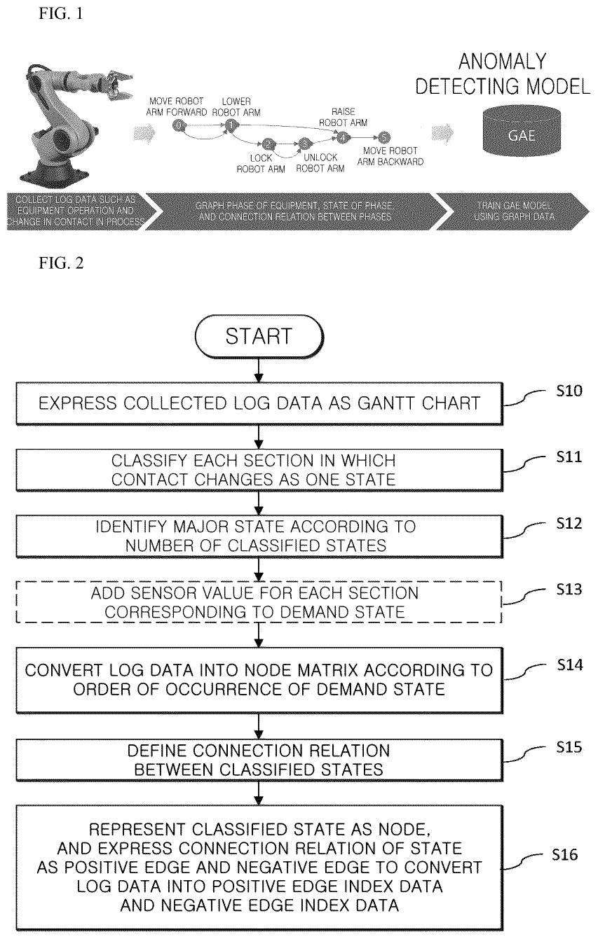

FIG. 1 is a reference diagram of an overall flow of the present invention disclosed in the present disclosure

Referring to FIG. 1, the invention disclosed in the present disclosure may be performed in the order of “a method of generating graph data” which collects data and pre-processes the collected data, and “a method of training an anomaly detecting model” using the generated graph data. Hereinafter, the “method of generating graph data” and the “anomaly detecting model training method” will be described in more detail in the present disclosure. Each operation of the “method of generating graph data” and the “method of training anomaly detecting model” according to the present disclosure may be executed by a processor.

FIG. 2 is a schematic flowchart of a method of generating graph data according to the present disclosure.

First, the log data collected in operation S10 may be expressed as a Gantt chart.

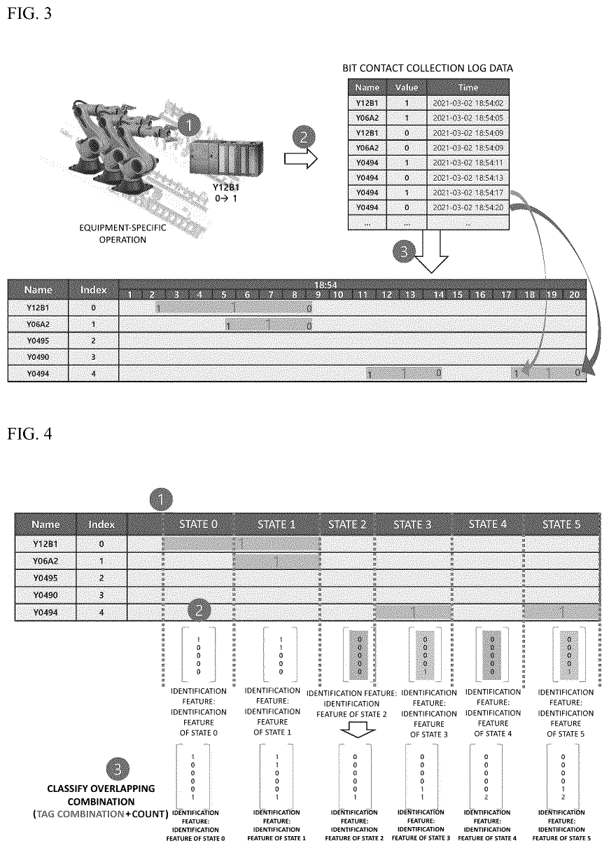

FIG. 3 is a reference diagram for the collection of the log data.

The data, that is, the log data, may be collected. In the example illustrated in FIG. 3, “1” means that the contact changes from the “off” state to the “on” state, and “0” means that the contact changes from the “on” state to the “off” state. The collected log data may be expressed as the Gantt chart as shown in FIG. 3.

Referring back to FIG. 2, in the next operation S11, in the log data expressed as the Gantt chart, each section in which the contact point value changes may be classified as one state.

FIG. 4 is a reference diagram for state classification and state identification features.

Referring to FIG. 4, it can be seen that the section is classified whenever a change in the contact point value occurs (\textcircled{1}). Also, it is possible to give an identification feature for classifying the state according to the changed contact point value (\textcircled{2}). According to the example illustrated in FIG. 4, an “on” contact point is represented by “1” and an “off” contact point is represented by “0”, so it can be seen that the identification features in which “state 0” is [10000], “state 1” is [11000], and “state 2” is are given. On the other hand, “state 2” and “state 4” have the same identification features as [00000], and “state 3” and “state 5” have the same identification features as [00001]. In this case, the information on the number of overlapping identification features may be added (\textcircled{3}).

Referring back to FIG. 2, in the next operation S12, the number of states having the same identification feature may be counted, and a state having a number greater than or equal to a preset value may be identified as a major state.

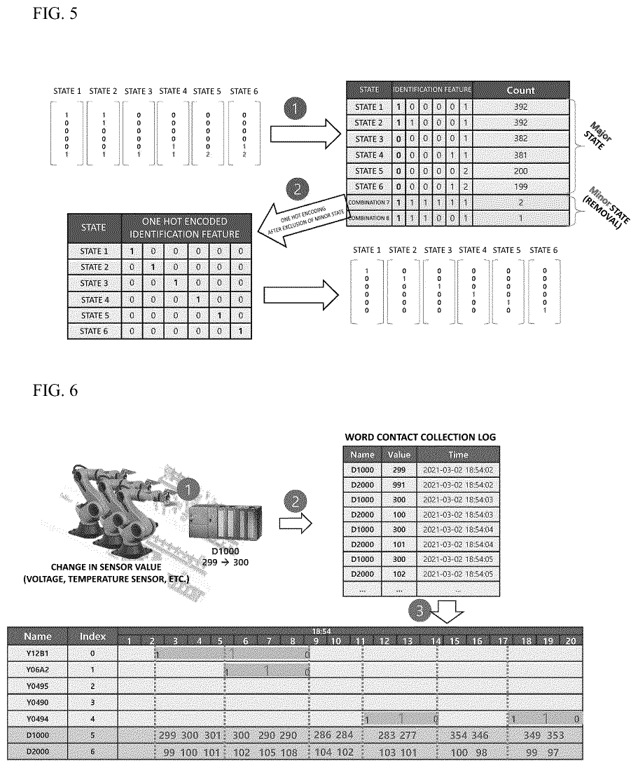

FIG. 5 is a reference diagram for identifying a major state.

Referring to FIG. 5, the number of states having identification features may be checked (\textcircled{1}). According to the number, a state (major) that occurs frequently and a state (minor) that occurs infrequently may be distinguished. The frequently occurring state may be identified as the “major state,” and the infrequent state may be deleted. Preferably, the identified major state may be assigned an identification code in One Hot Encoding format. Through the One Hot Encoding, the major state may be distinguished by a single attribute value, and the machine learning process may be easier in the future.

The method of generating graph data according to the present disclosure may further include adding at least one sensor value for each section corresponding to the major state (operation S13 in FIG. 2).

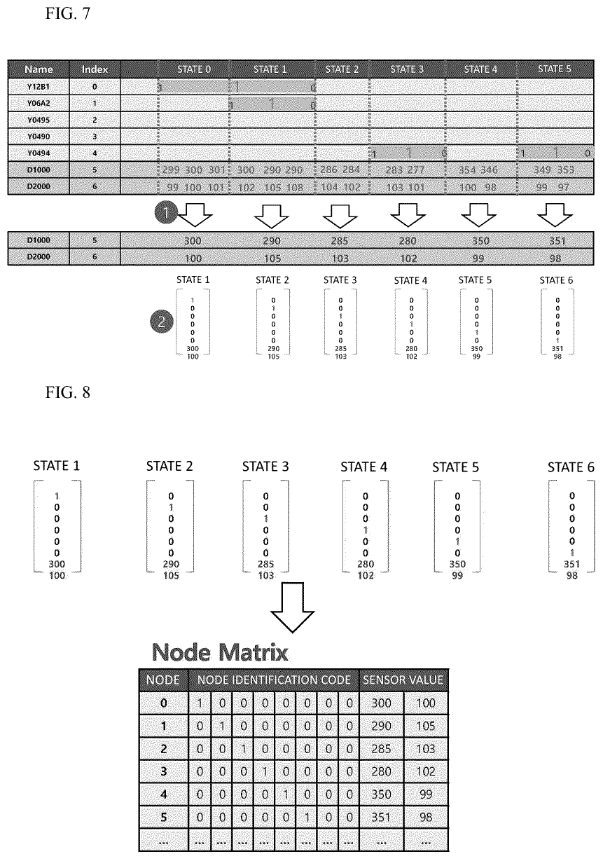

FIGS. 6 and 7 are reference diagrams for adding sensor values for each section.

Referring to FIG. 6, various sensors such as a voltage sensor and a temperature sensor may be attached to the equipment, and a sensing value may be output from each sensor (\textcircled{1}). The output sensing value may be collected using a log (\textcircled{2}). When the sensing value is expressed corresponding to each section according to the output time, the sensing value may be expressed as illustrated in FIG. 6 (\textcircled{3}). Although values output from the two sensors “D1000” and “D2000” are illustrated in FIG. 6, the types and number of sensors may vary.

Referring to FIG. 7, there may be two or more sensor values output from one sensor within one section. For example, during the “state 0” section, the “D1000” sensor outputs “299, 300, 301” values. In this case, a representative value (e.g., average value “300”) may be selected (\textcircled{1}) and added to the main “state 1” (\textcircled{2}).

Referring back to FIG. 2, in operation S14, the log data may be converted into node matrix data according to the order of occurrence of the major state.

FIG. 8 is a reference diagram in which the log data is converted into the node matrix data.

Referring to FIG. 8, each major state corresponds to one node, and each node corresponds to an identification code. When converting into the node matrix data, the node should maintain the order of the log data.

Referring back to FIG. 2, the connection relationship between the classified states may be defined in operation S15. The connection relationship may be a necessary condition or an exclusive condition.

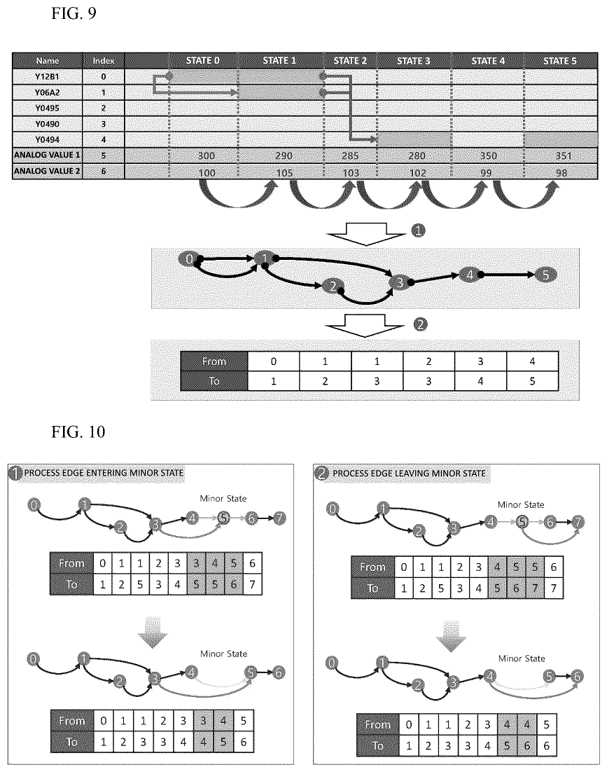

FIG. 9 is a reference diagram illustrating that a connection relationship is defined between adjacent states.

Referring to FIG. 9, “Y12B1” is “ON” in state 0, and “Y06A2” is “ON” in state 1. In this case, in order for “Y06A2” to be “ON,” “Y12B1” should be “ON,” and “state 0” is a “necessary condition” relationship of “state 1.” In addition, in state 1, “Y12B1” and “Y06A2” should be “OFF,” and thus, in state 3, “Y0494” is “ON.” In this case, in order for “Y0494” to be “ON,” “Y12B1” and “Y06A2” should be “OFF,” and “state 1” is a “necessary condition” relationship of “state 3.”

Referring back to FIG. 2, in operation S16, the classified state is represented as a node, and the connection relationship of the classified state is expressed as a positive edge and a negative edge, and the log data may be converted into positive edge index data and negative edge index data.

A method of generating positive edge index data will first be described with reference to FIG. 9 again. It can be seen that states are expressed as a graph connected by an edge and an edge index.

Meanwhile, since the node matrix includes only information on the “major state,” the edge index also leaves only the node for the major state, and it is necessary to remove the node corresponding to the state (Minor) that occurs infrequently. According to the embodiment of the present disclosure, it is possible to delete a node that does not correspond to the major state from the node matrix data, and convert data into a positive edge index by connecting previous and subsequent nodes connected to the deleted node.

FIG. 10 is a reference diagram for removing a node corresponding to a minor state.

Referring to FIG. 10, node No. 5, which does not correspond to the major state, is a deletion target. In the example illustrated on the left, there is a relationship that node Nos. 3 and 4 go to node No. 5, and node No. 5 goes to node No. 6. Therefore, it is possible to delete node No. 5 and change node Nos. 3 and 4 to directly enter node No. 6. In this case, node No. 6 is changed to node No. 5 according to the node order, and node No. 7 is changed to node No. 6. In the example illustrated on the right, there is a relationship that node No. 4 goes to node No. 5, and node No. 5 goes to node Nos. 6 and 7. Therefore, it is possible to delete node No. 5 and change node No. 4 to go to node Nos. 6 and 7. In this case, node No. 6 is changed to node No. 5 according to the node order, and node No. 7 changed to node No. 6. Through the above process, the node of the node matrix data and the node of the edge index data may have a mutually corresponding relationship. Through the above process, the log data (raw data) is converted into node matrix data and positive edge index data.

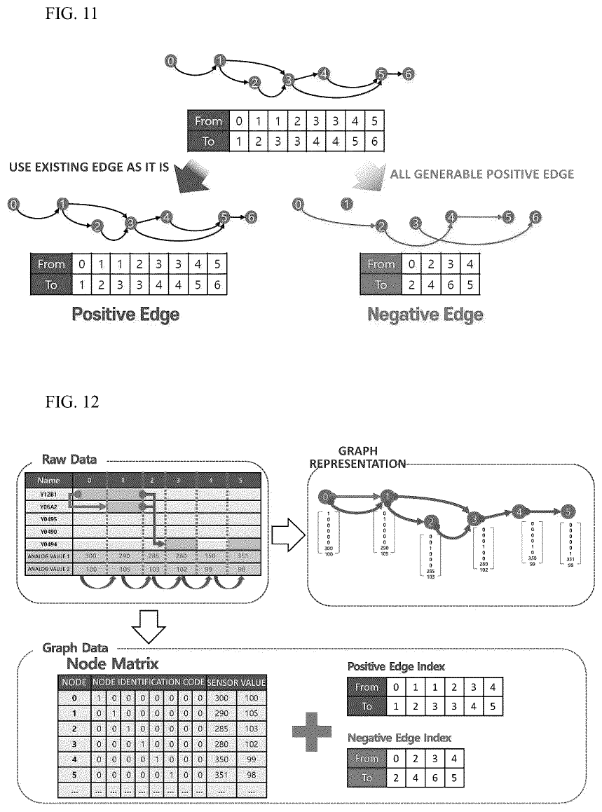

FIG. 11 is a reference diagram of a method of generating a negative edge index.

Referring to FIG. 11, the positive edge described above with reference to FIG. 10 may be checked. According to an embodiment of the present disclosure, among all edges that can be generated between nodes, edges other than the positive edge may be converted into negative edge index data.

When the positive edge index data and the negative edge index data are combined with node matrix data, the resultant may be expressed as graph data.

FIG. 12 is a reference diagram for relationships between the log data, the node matrix data, the positive edge index data, the negative edge index data, and the graph data.

Meanwhile, in the production process, it is common that the same equipment repeats the same operation. Accordingly, the collected log data (raw data) will also repeat a cycle including similar data, and in this case, one piece of graph data may correspond to one cycle.

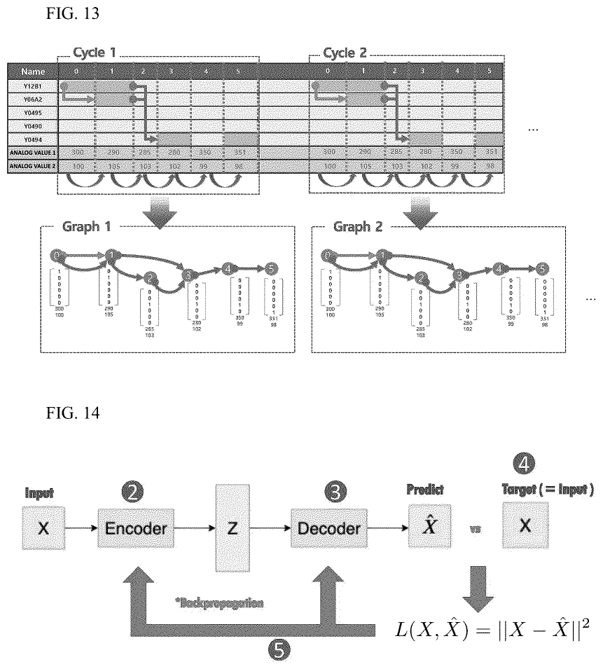

FIG. 13 is a reference diagram of relationships between the graph data and cycles.

Hereinafter, the method of training an anomaly detecting model will be described using graph data (node matrix data+positive/negative edge index data) generated according to the method of generating graph data according to the present disclosure.

Before training (learning) the model, AutoEncoder will be described.

FIG. 14 is a reference diagram of the AutoEncoder.

Referring to FIG. 14, the AutoEncoder may include an encoder and a decoder. The encoder compresses input data (input ‘X’) into low-dimensional embedding (Z), and the decoder reconstructs the compressed low-dimensional embedding (Z) into high-dimensional data (In this case, by comparing the result value (Predict) and the target data (same as input data ‘X’), the encoder and decoder are trained in the direction of minimizing a difference value (loss) between the two pieces of data. Therefore, when the AutoEncoder is trained with a large amount of data, the difference value (loss) of the data reconstructed for the major state (major) among the input data will be small, and the difference value (loss) of the data reconstructed for the minor state (minor) will be large. It is possible to train a model that detects abnormal data included in the data set by using the difference in the size of the difference value (loss) of this reconstructed data.

In particular, the AutoEncoder can be freely applied by changing a network used for the encoder and decoder according to the type of target data. For image data, a convolution neural network (CNN) is used for the encoder and decoder, and for table data, a multi layered perceptron (MLP) is used for the encoder and decoder. Considering this, the method of generating a master state according to the present disclosure is extended to graph data using a graph neural network (GNN) for the encoder and decoder.

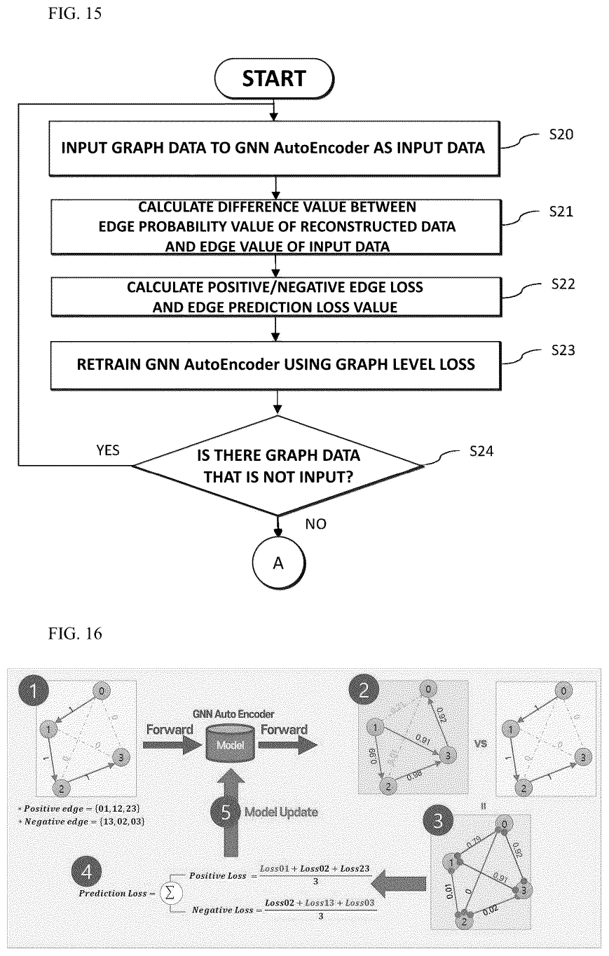

FIG. 15 is a schematic flowchart of a method of training an anomaly detecting model according to the present disclosure.

FIG. 16 is a reference diagram of a method of training an anomaly detecting model according to the present disclosure.

Referring to FIG. 15, first, in operation S20, one of a plurality of pieces of graph data may be input to the GNN AutoEncoder as input data (\textcircled{1} in FIG. 16). According to an embodiment of the present disclosure, a value of the positive edge of the graph data may be set to “1” and a value of the negative edge may be set to “0.”

The GNN AutoEncoder may calculate the probability of each edge. Accordingly, the reconstructed data output by the GNN AutoEncoder may be included by calculating a value for the probability that an edge is present (\textcircled{2} in FIG. 16).

In the next operation S21, a difference value (hereinafter, “edge difference value”) between an edge probability value of the reconstructed data output by the GNN AutoEncoder and an edge value of the input data may be calculated (see \textcircled{3} in FIG. 16). For example, the edge value of the input data is “1” because there is a positive edge between the node “0” and the node “1” of the input data. The probability value between the node “0” and the node “1” of the reconstructed data is “0.21.” Therefore, the edge difference value is calculated as “1−0.21=0.79”.

In the next operation S22, an average value (hereinafter, “positive edge loss”) of the positive edge and an average value (hereinafter, “negative edge loss”) of the negative edge may be calculated using the edge difference value. The positive edge loss (positive loss) is an average value of an edge difference value for a portion where the positive edge is present in the input data. Similarly, the negative edge loss (negative loss) is the average value of the edge difference values for the portion where the negative edge is present in the input data. By summing the positive edge loss and the negative edge loss, it is possible to calculate an edge prediction loss value of the reconstructed data (\textcircled{4} in FIG. 16). As the edge prediction loss value is lower, the reconstructed data predicts the input data similarly, and as the edge prediction loss value is higher, the reconstructed data does not sufficiently predict the input data.

In the next operation S23, the GNN AutoEncoder may be retrained until the edge prediction loss value is minimized (\textcircled{5} in FIG. 16).

In the next operation S24, it may be determined whether graph data that has not yet been inputted, among the plurality of pieces of graph data, remains. When there is graph data that has not been input (YES in S24), the process may proceed to operation S20. At operation S20, operations S20 to S24 may be repeatedly executed while inputting one piece of graph data that has not yet been input, among the plurality of pieces of graph data, to the GNN AutoEncoder as input data.

Meanwhile, when the plurality of pieces of graph data are all input to the GNN AutoEncoder, the GNN AutoEncoder is in a learned state. Thereafter, it is possible to determine whether the relationship is abnormal using the GNN AutoEncoder whose learning has been completed. However, it is necessary to set a standard for determining whether there is an abnormality.

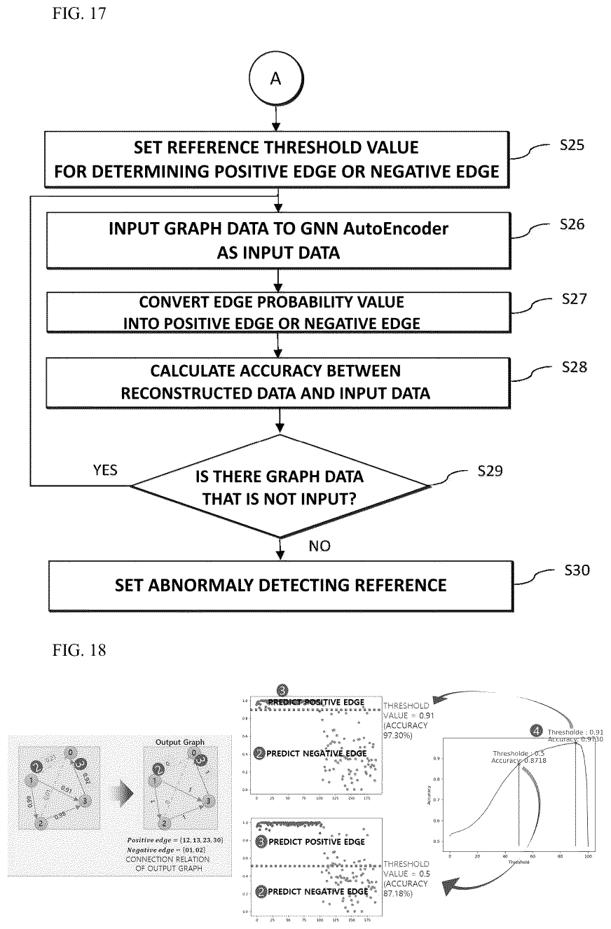

FIG. 17 is a schematic flowchart of reference setting of an anomaly detecting model according to the present disclosure.

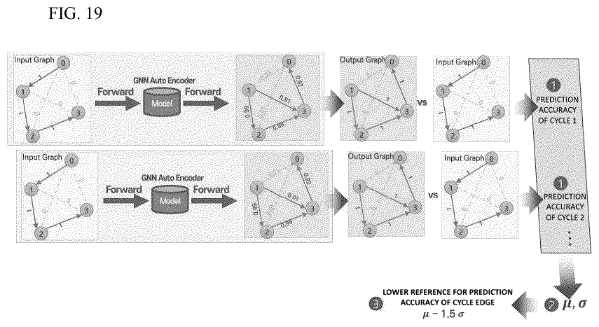

FIGS. 18 and 19 are reference diagrams of the reference setting of the anomaly detecting model according to the present disclosure.

In operation S25, a reference threshold value for determining the positive edge or the negative edge may be set according to the calculated edge probability value. Referring to FIG. 18, the edge probability value between node “0” and node “1” of the reconstructed data is calculated as “0.21.” The edge having the probability value of 0.21 is naturally determined as a negative edge, but a reference value, that is, a reference threshold value, is required to determine whether the edge is a negative edge or a positive edge according to the calculated probability value. Accuracy may also change according to the setting of the reference threshold value.

In the next operation S26, one piece of graph data that has not yet been input, among the plurality of pieces of graph data, may be input to the GNN AutoEncoder that calculates the probability of each edge as input data. The GNN AutoEncoder has completed learning to calculate the edge probability through operations S20 to S24. Accordingly, the reconstructed data is output in a form including the edge probability value.

In the next operation S27, the edge probability value of the reconstructed data output by the GNN AutoEncoder may be converted into a positive edge or a negative edge according to the reference threshold value. Accordingly, all edges included in the reconstructed data may be changed to a value of “1” or “0.”

In the next operation S28, it is possible to calculate the accuracy between the reconstructed data converted into the positive edge or the negative edge and the input data.

In the next operation S29, it may be determined whether graph data that has not yet been inputted, among the plurality of pieces of graph data, remains. When there is graph data that has not been input (YES in S29), the process may proceed to operation S26. At operation S26, operations S26 to S29 may be repeatedly executed while inputting one piece of graph data that has not yet been input, among the plurality of pieces of graph data, to the GNN AutoEncoder as input data. On the other hand, when all of the plurality of pieces of graph data are input to the GNN AutoEncoder as input data (NO in S29), the process may proceed to operation S30.

In operation S30, an average (μ) and a standard deviation (σ) of the accuracy may be calculated, and the anomaly detecting standard may be set by subtracting the standard deviation value in which a preset parameter is reflected from the average value. For example, when the preset parameter is 1.5, the anomaly detecting standard may be “μ−1.50σ.”

The artificial neural network learned according to the above description is capable of tracking not only whether there is an error in the cycle when data of a new cycle is input, but also at which contact point or/and which link an error occurs. The method of generating a master pattern and a method of training a cycle analysis model according to the present disclosure are a technology for processing a machine control language (low-level language) that is difficult for humans to analyze and converting the machine control language into an analytic language (high-level language), i.e., a machine language processing (MLP)-based technology that may analyze the executed machine language (language that controls a machine) with a computer and may be understood by humans, and therefore, are different from the related art. By using the cycle analysis model according to the present disclosure, it is possible to analyze and graph the association of static and dynamic data flows while a device to be analyzed is controlled by using an anomaly detecting model, and provide various services such as control logic inspection, control logic generation, real-time anomaly detection, reproduction, and productivity and quality analysis.

Meanwhile, the method of generating graph data and the method of generating a master state according to the present disclosure may be implemented by processors, an application-specific integrated circuit (ASIC), other chipsets, logic circuits, registers, communication modems, data processing devices, and the like known in the art for executing the described calculations and various types of control logic. In addition, when the above-described control logic is implemented in software, the processor may be implemented as a set of program modules. In this case, the program module may be stored in the memory device and executed by the processor.

In order for the computer to read the program and execute the methods implemented as the program, the program may include code coded in a computer language such as C/C++, C #, JAVA, or machine language that the processor (CPU) of the computer may read through a device interface of the computer. Such code may include functional code related to functions defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions are to be referenced at. In addition, when the processor of the computer needs to communicate with any other computers, servers, or the like located remotely in order to execute the above functions, the code may further include communication-related code for how to communicate with any other computers, servers, or the like using the communication module of the computer, what information or media to transmit/receive during communication, and the like.

The storage medium is not a medium that stores images therein for a short time, such as a register, a cache, a memory, or the like, but means a medium that semi-permanently stores data therein and is readable by an apparatus. Specifically, examples of the storage medium include, but are not limited to, a read-only memory (ROM), a random-access memory (RAM), a CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and computer-readable code may be stored in a distributed manner.

According to one aspect of the present disclosure, it is possible to generate a model capable of detecting anomalies from log data based on a GNN.

According to another aspect of the present disclosure, it is possible to analyze and graph the association of static and dynamic data flows while a device to be analyzed is controlled by using an anomaly detecting model, and provide various services such as control logic inspection, control logic generation, real-time anomaly detection, reproduction, and productivity and quality analysis.

Effects of the present disclosure are not limited to the above-described effects, and other effects that are not mentioned will be clearly understood by those skilled in the art from the following descriptions.

Although embodiments of the present disclosure have been described with reference to the accompanying drawings, those skilled in the art will appreciate that various modifications and alterations may be made without departing from the spirit or essential features of the present disclosure. Therefore, it should be understood that the above-described embodiments are not restrictive but are exemplary in all aspects.

What is claimed is:

1. A method of training an anomaly detecting model using a plurality of pieces of graph data, the method comprising:
(a) inputting one piece of graph data that has not yet been input, among the plurality of pieces of graph data, to a graph neural network (GNN) AutoEncoder calculating a probability of each edge as input data;
(b) calculating a difference value (hereinafter, “edge difference value”) between an edge probability value of reconstructed data output by the GNN AutoEncoder and an edge value of the input data;
(c) calculating an average value (hereinafter, “positive edge loss”) of a positive edge and an average value (hereinafter, “negative edge loss”) of a negative edge using the edge difference value, and calculating an edge prediction loss value of the reconstructed data by summing the positive edge loss and the negative edge loss;
(d) retraining the GNN AutoEncoder until the edge prediction loss value is minimized; and
(e) repeatedly executing the operations (a) to (d) when there remains graph data that has not yet been input, among the plurality of pieces of graph data.

2. The method of claim 1, wherein a value of the positive edge of the graph data is set to “1” and a value of the negative edge is set to “0.”

3. The method of claim 1, further comprising:
(f) setting a reference threshold value for determining the positive edge or the negative edge according to the calculated edge probability value;
(g) inputting one piece of graph data that has not yet been input, among the plurality of pieces of graph data, to a graph neural network (GNN) AutoEncoder calculating a probability of each edge as input data;
(h) converting the edge probability value of the reconstructed data output by the GNN AutoEncoder into the positive edge or the negative edge according to the reference threshold value;
(i) calculating accuracy between the reconstructed data converted into the positive edge or the negative edge and the input data;
(j) repeatedly executing operations (f) to (i) when there remains graph data that has not yet been input, among the plurality of pieces of graph data; and
(k) when all of the plurality of pieces of graph data are input to the GNN AutoEncoder as input data, calculating an average and a standard deviation of the accuracy, and subtracting a standard deviation value in which a preset parameter is reflected from the average value to be set as an anomaly detecting standard.

4. A computer program written to allow a computer to execute each operation of the method of training an anomaly detecting model according to claim 1 and recorded on a computer-readable recording medium.

5. The method of claim 1, wherein the plurality of pieces of graph data generated according a method of generating graph data for detecting anomaly, comprising:
(a) classifying each section in which a contact point value changes in log data expressed as a Gantt chart as one state;
(b) identifying a major state in the classified states, and converting the log data into a node matrix according to an order of occurrence of the major state; and
(c) converting the log data into edge index data by defining a connection relation between the classified states, expressing the classified state as a node, and expressing the connection relation of the classified state as a positive edge and a negative edge to convert the log data into positive edge index data and negative edge index data.
